(19) United States
(12) Patent Application Publication
(10) Pub. No.: US 2012/0032933 A1
(43) Pub. Date: Feb. 9, 2012

(54) ELECTRONIC DEVICE HAVING SOLAR ENERGY MODULE

(75) Inventor: PING-YANG CHUANG, Tu-Cheng (TW)

(73) Assignee: HON HAI PRECISION INDUSTRY CO., LTD., Tu-Cheng (TW)

(21) Appl. No.: 12/977,074

(22) Filed: Dec. 23, 2010

(30) Foreign Application Priority Data
Aug. 9, 2010 (TW) 99126502

(51) Int. Cl. G09G 5/00

(52) U.S. Cl. 345/207

(57) ABSTRACT

An electronic device includes a display and a housing configured to house the display. A solar energy module is arranged in the housing, and configured for converting light into electricity. A light guide member includes an optical film with a micro-structure, which guides light incident on the light guide member to be split at a preset angle. The light guide member is arranged on and covers the display, and is configured for guiding incident light to the solar energy module.

### RELATED APPLICATIONS

This application is related to U.S. patent application with an Attorney Docket Number of US33149 and a title of ELECTRONIC DEVICE HAVING SOLAR ENERGY COLLECTING MODULE, which has the same assignee as the current application and was concurrently filed.

### BACKGROUND

1. Technical Field

The present disclosure relates to electronic devices with solar energy modules and, particularly, to an electronic device having a light guiding module to guide ambient light to the solar energy module.

2. Description of Related Art

Energy consumption of portable consumer electronic products has always been a concern. There are portable consumer electronic products equipped with solar cells or panels to collect solar energy. An extra opening in the housing of the electronic product is often needed to allow ambient light to pass through, which may affect the appearance of the electronic product.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic cross-sectional view of a portable electronic device in accordance with one embodiment.

FIG. 2 is a schematic cross-sectional view of a portable electronic device in accordance with a second embodiment.

### DETAILED DESCRIPTION

Embodiments of the present disclosure will now be described in detail below, with reference to the accompanying drawings.

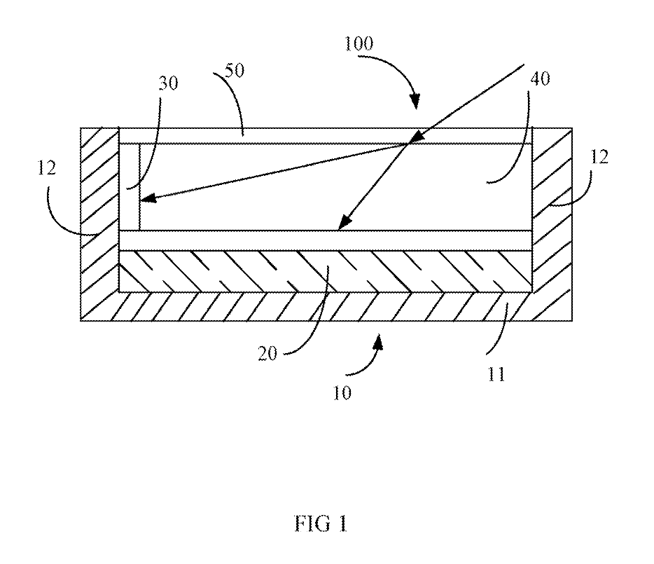

Referring to FIG. 1, an electronic device 100 includes a housing 10 and a display 20. The housing 10 includes a bottom 11 and two opposite sidewalls 12. The display 20 is received in a space defined by the bottom 11 and the sidewalls 12. The electronic device 100 further includes a solar energy module 30 and a light guide member 40. The solar energy module 30 is arranged on an internal sidewall 12 of the housing 10 and is used to convert light into electricity.

The light guide member 40 is arranged above and covers the display 20. In the embodiment, the light guide member 40 is made of transparent material. The light guide member 40 includes an optical film with a micro-structure, to guide a portion of light incident on the light guide member 40 to be split at a preset angle. When light strikes the top of the light guide member, much of the light is guided to the solar energy module 30, and the remainder is guided directly to the display 20. The electricity produced by the solar energy module 30 can be used to power the electronic device 100.

In the embodiment, the display 20 can be a reflective type display, such as a microcapsule type electronic paper display. The display 20 can use light passing through the light guide member 40 as a light source. In the embodiment, the electronic device 100 further includes a protection layer 50 arranged between the sidewalls 12 of the housing, to protect the light guide member 40 from being scratched.

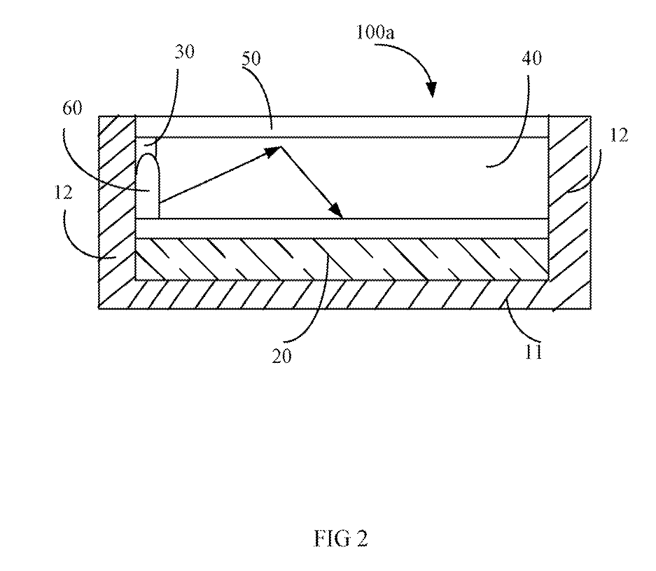

Referring to FIG. 2, in an alternative embodiment, an electronic device 100a is disclosed. The difference between the electronic devices 100 and 100a is that the electronic device 100a further includes a lighting module 60. The lighting module 60 is arranged on the sidewall 12 where the solar energy collecting module 30 is arranged. When the ambient light is weak, the lighting module 60 can be turned on to emit light, a portion of which can pass through the light guide member 40 to the display 20. Thus, information displayed by the electronic device 100a can still readable in poor light conditions. In the embodiment, the lighting module 60 includes a number of light emitting diodes (LEDs).

In other embodiments, the display 20 can be a half reflection type liquid crystal display or a backlit display. When the display 20 is a backlit display, the lighting module 60 is not needed.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. An electronic device comprising:
a display;
a housing receiving the display;
a solar energy module arranged in the housing, and configured for converting light into electricity; and
a light guide member arranged on and covering the display, and configured for guiding incident light to the solar energy collecting module;
wherein the light guide member comprises an optical film with a micro-structure, to guide a portion of light beams incident on the light guide member to be split at a preset angle.

2. The electronic device according to claim 1, wherein the display is a reflective type display.

3. The electronic device according to claim 1, further comprising a protection layer arranged over the light guide member.

4. The electronic device according to claim 1, wherein the solar energy module is arranged on an internal sidewall of the housing.

5. An electronic reader comprising:
a display;
a housing receiving the display;
a solar energy module arranged in the housing, and configured for converting light into electricity;
a lighting module arranged in the housing; and
a light guide member arranged on and covering the display, and configured for guiding incident light to the solar energy module, wherein the light guide member comprises an optical film with a micro-structure, to guide a portion of light beams incident on the light guide member to be split at a preset angle, light from the lighting module is able to pass through light guide member to the display.

6. The electronic reader according to claim 5, wherein the display is a reflective type display.

7. The electronic reader according to claim 5, further comprising a protection layer arranged over the light guide member.

8. The electronic reader according to claim 5, wherein the lighting module comprises a plurality of light emitting diodes.

9. The electronic reader according to claim 5, wherein the solar energy module is arranged on one inner sidewall of the housing, the lighting module is arranged on the sidewall where the solar energy module is arranged.
